(19) United States
(12) Patent Application Publication
(10) Pub. No.: US 2007/0136373 A1
(43) Pub. Date: Jun. 14, 2007

(54) Intellectual property portfolio management method and system

(76) Inventors: David J. Piasecki, Hoffman Estates, IL (US); Daniel L. Ellig, Arlington Heights, IL (US); William J. Harper, Chicago, IL (US); James C. Paschall, Arlington Heights, IL (US); Paul R. Sedlacek, Hawthorn Woods, IL (US); John G. Tolomei, Lake Zurich, IL (US); Herman A. Zinnen, Evanston, IL (US)

Correspondence Address: HONEYWELL INTELLECTUAL PROPERTY INC;PATENT SERVICES, 101 COLUMBIA DRIVE, P O BOX 2245 MAIL STOP AB/2B, MORRISTOWN, NJ, 07962, US

(21) Appl. No.: 11/302,597

(22) Filed: Dec. 14, 2005

(51) Int. Cl. G06F 17/00

(52) U.S. Cl. 707/104.1

(57) ABSTRACT

A method and system for managing intellectual property (IP). An IP filing for an IP asset is displayed in a display matrix on a computer screen. A status for the IP filing is indicated through the display matrix. A filing instruction or a prosecution instruction for the IP filing is obtained through the display matrix.

### FIELD OF THE INVENTION

The field of the invention is a method and system for managing intellectual property. Data, including the status, of intellectual property is displayed on a computer screen as a display matrix. A filing instruction or a prosecution instruction for the intellectual property is obtained through the display matrix.

### BACKGROUND OF THE INVENTION

The decision to file or proceed with domestic and/or foreign patent applications often requires the input of more than one party, particularly in larger companies. Such parties can include, for example, the patent counsel, the inventor and a business group manager. The need to make a filing or maintenance decision is usually triggered by a deadline for an individual case. Exemplary situations include: 1) a list of all patents with a maintenance payment due during a future time period, such as the next month or quarter, are sent to the decision maker so they can respond; 2) at some point before the decision needs to be made the decision maker is notified that a decision is required, e.g., 2 months before the one year anniversary of the earliest filing date a foreign filing decision is needed; or 3) requests for decisions to request examination of applications are also time dependent in several countries.

The requests are made for individual inventions or for a group of inventions all having the same deadline, but information regarding other cases related by priority or business interest is generally not included in the requests. These requests are usually made to the decision maker so that the proper action can be completed by the agent (including law firms, in-house patent groups). In some cases, the decision maker sends out a similar request to get input from other people in the organization before making the decision. Thus, in the current systems the decisions are made (perhaps in haste) to meet a near term deadline and the information provided in the request is limited to the specific case.

There is a need to improve the decision making process for determining where intellectual property applications should be filed and maintained. The manner in which information is exchanged during the decision making process also needs to be improved.

### SUMMARY OF THE INVENTION

A general goal of the invention is to improve the management of intellectual property.

A more specific goal of this invention is to overcome one or more of the problems described above.

A general goal of this invention can be attained, at least in part, through a method of managing intellectual property (IP). The method includes displaying an IP filing for an IP asset in a display matrix on a computer screen. A status is indicated for the IP filing through the display matrix. The method further obtains an instruction selected from the group consisting of a filing instruction and a prosecution instruction, for the IP filing through the display matrix. In addition, the method may obtain a maintenance instruction.

The invention further comprehends another method of managing intellectual property (IP). The method includes viewing IP filings for an IP asset in a display matrix on a computer screen and providing an instruction selected from the group consisting of a filing instruction and a prosecution instruction, for one of the IP filings through the display matrix.

The invention still further comprehends a method of managing intellectual property (IP). The method includes displaying IP assets of an IP portfolio in a display matrix on a computer screen, displaying an IP filing in a region for one of the IP assets, determining a filing assessment for the IP filing, indicating the filing assessment through the display matrix, and obtaining an instruction for the IP filing.

The invention also comprehends a system for managing intellectual property (IP). The system comprises a network including more than one user interface and a database for storing information about an IP asset. The system further comprises software including code for creating a display matrix within a browser for viewing on the more than one user interface. The display matrix includes a table listing the IP asset along a first axis and listing a region along a second axis. The table includes a cell correspondingly aligned with the IP asset along the first axis and the region along the second axis. The cell represents an IP filing for the IP asset in the correspondingly aligned region.

The method of this invention can be implemented using a system that provides various displays on a computer screen, such as, web pages, windows, and forms that are linked to stored data. The data may be stored in any format that can be linked to the display. Although some formats such as a relational database offer certain advantages, other non-limiting examples of data storage that can be used include flat files, spreadsheets, formatted text file, XML file, and non-relational databases. The system may use any combination of these and or other data storage formats. In one embodiment of this invention, a display matrix shows the status of all IP assets and IP filings grouped into a portfolio so that filing and maintenance decisions can be made in light of the status of all related IP assets and filings. The display matrix can include a table where the group of IP filings, e.g., patent applications, corresponding to an IP asset, e.g., an invention, is displayed in a row, and the countries or regional offices, collectively “regions,” for filing are indicated in columns. The method also includes ways to assess or rate the countries and the IP assets and indicate and use these ratings in the display matrix. Input is recorded in a database when users interact with the web pages (clicking or typing), and the display matrix is updated, desirably automatically, to reflect the new information and the status of individual IP filings. The recorded input can be provided as instructions to a decision maker for final approval before being recorded as an action for the agent to complete, or it may be provided directly to the agent for action. The method and system of this invention permit a proactive approach to managing an IP portfolio; since current data are displayed, the users can schedule regular reviews of a portfolio and provide a set of consistent input (instructions) for the entire portfolio at one time.

Other variations of this invention include a way to associate a list of countries with a portfolio and means of rating the countries so they can be prioritized differently for individual portfolios. Also, other data for each IP filing besides the status can be displayed in the matrix to provide additional information such as the expected cost for this year, future lifetime costs, actual costs incurred to date, the age, maximum remaining years, type of application, etc.

Information about each IP filing to be included in the system is recorded in some form (e.g., paper or electronic). Electronic herein means any type of file that can be stored on media (tape, disks, CD, DVD, etc.) and accessible from a PC, server, mainframe, etc. At a minimum, this information would include its status (pending, granted, expired, appealed, abandoned, rejected, etc.) for each country. Additional information about each IP asset and/or IP filing can be stored and used to make the system even more useful. Such data include but are not limited to, the type of application, relationships to other applications (e.g., divisional, continuation-in-part, priority, etc.), various dates (e.g., filing, grant, publication, expiration, etc.), list of inventors, title, abstract, etc.

The IP assets and IP filings are grouped into IP portfolios which are defined by the system provider and/or customer or user. The system provider and customer or user may be the same entity such as when one entity undertakes to create and/or use the system internally. Or, the system provider may be a service company or consultant that provides the system to a law firm, inventor, or company that will use the system internally and/or in dealing with their respective customers/clients. Thus, there will also be a record of each IP portfolio which may consist of only a single identifying field (ID) but will usually include more information such as an ID, and name. Naturally, other data regarding an IP portfolio may also be recorded. For example, the IP portfolios may be organized into a relational structure so that the system is adaptable to any business structure for a single or multiple clients. The IP assets are associated with the desired IP portfolios to suit the customer definitions and requirements.

A variety of systems can be used to deploy the invention. Although a manual paper system could be created and maintained, it would be labor intensive, expensive, errors would be difficult to detect, and it would not have sufficient response time for any but the smallest set of inventions. Systems where electronic files, such as text documents, spreadsheets, databases, or combinations thereof, are shared either by routing the same file(s) among different users or having multiple users access the same file(s) on a server may be used. In another embodiment the system comprises web pages which serve as the user interface and a database. This system provides excellent accessibility, security, response time and flexibility to integrate with other systems such as different databases, e-mail and customization of the system to meet specific client needs. Input and instructions to an agent can be captured in a variety of ways within or outside the system (e.g., phone, mail, fax, email).

The method and system of this invention encompass the display of other data besides patent applications. A matrix can be readily used to show the status of any property (patents, trademarks, products, services, possible acquisitions, projects, etc.) relative to a country, geographical region, market segment, business group, etc.

As used herein, references to the term “IP asset” refer to the subject matter that is the basis for the intellectual property, such as for example, the invention, the trademark or service mark, or the original work of authorship. References herein to an “IP filing” refer to an actual or potential filing opportunity to patent, register, or otherwise protect the IP asset in a region.

As used herein, the term “region” refers to a country or an organization of countries, such as the Patent Cooperation Treaty or European Patent Office, that has a system in place to accept applications for protecting IP assets.

As used herein, references to the term “instruction” includes recommendations as well as directions.

### BRIEF DESCRIPTION OF THE DRAWINGS

FIG. 1 is a simplified flow diagram illustrating a method according to one embodiment of this invention.

FIGS. 2-8 are screen displays displayed by a computer system implementing the method of one embodiment of this invention.

### DETAILED DESCRIPTION OF THE INVENTION

The invention is a method and a system for managing intellectual property (IP). The method and system have particular usefulness for managing IP filings in different countries and regions. While the invention will be described herein referring to inventions, patent applications and patents, those skilled in the art will appreciate that the invention is not intended to be limited to this one type of intellectual property. The method and system of this invention can be applied to other intellectual property, such as, for example, trademarks and copyrights.

In one embodiment of this invention, a display matrix is provided in a browser window on a computer screen. The display matrix desirably displays the status of all IP filings grouped into an IP portfolio. The display matrix, and the information indicated thereby, allows for more informed and efficient filing and maintenance decisions, as these decisions can be made in light of the status of all portfolio inventions and applications. The display matrix is desirably interactive and as system users input information and instructions, the system records the inputted data and updates the display matrix to reflect the new information. The recorded input can be provided as instructions to a decision maker for final approval. The system and method of this invention permit a proactive approach to managing a patent or other IP portfolio; as current data are displayed, the users can schedule regular reviews of a portfolio and provide a set of consistent input, e.g., instructions, for an entire IP portfolio at one time.

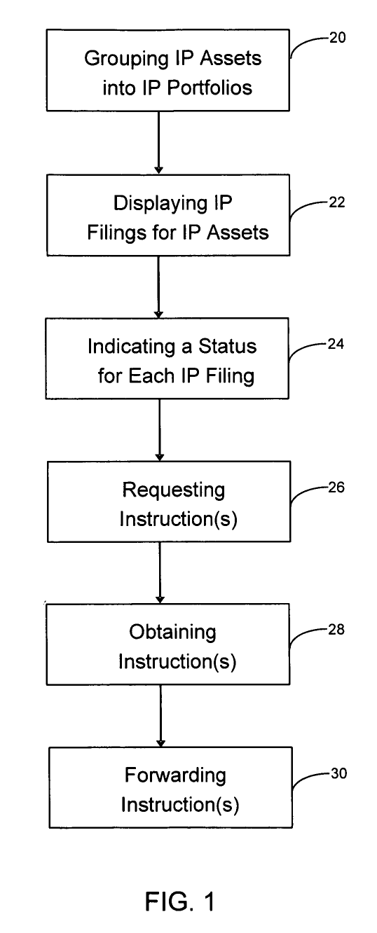

FIG. 1 is a flow diagram generally illustrating a method for managing intellectual property according to one embodiment of this invention. In step 20, a plurality of IP assets are grouped into one or more IP portfolios. The IP portfolios are defined by the system provider or IP asset owner. The I/P assets are desirably organized into a relational structure, and the system is adaptable to any business structure for a single or multiple clients. The IP assets are associated with the desired IP portfolios to suit the user's definitions and requirements. The IP portfolios may be organized by technology, product lines, market segments or any other system to the user requirements. Frequently, all of the IP filings related to a single IP asset will be in the same IP portfolio. However, systems with a complex business structure, or multiple clients, may require separating different IP filings stemming from one IP asset into different IP portfolios. This can be accomplished by including the IP asset in two or more IP portfolios.

In step 22, one or more IP filings for each of one or more IP assets in an IP portfolio are displayed for a review by an interested party. In one embodiment of this invention, the IP filings are displayed in a display matrix, desirably on a computer screen. The display matrix, discussed in more detail below, is generated using the records of the IP filings in the system for a given IP portfolio. The display matrix can be displayed using a browser, such as are available from, for example, Microsoft or Netscape, and contains links that provide more details about each IP filing or asset. For example, by clicking on an IP asset's title, a new browser page opens which provides additional details stored in a database concerning the original disclosure, or it can open the original disclosure or an image of it. Another link can be used to access any granted patents and/or publications directly from the U.S. Patent and Trademark Office's web site or the equivalent web sites from other countries' patent offices.

In step 24, a status for one or more of the IP filings is indicated through the display matrix. The method and system of this invention collect and provide status information of IP filings of grouped IP assets so that recommendations and/or decisions regarding the IP filings can be made efficiently with more information easily accessible to the decision maker, particularly information about related IP filings and assets. The status information provided through the display matrix can include an availability status (whether an IP filing is available), a filing status (whether the IP filing has been filed), a pendency status (whether the IP filing is filed and still pending), an issuance status (whether the IP filing has issued), an enforceability status (whether the issued IP filing is enforceable, for example, due to payment of all required maintenance, annuity or renewal fees), and combinations thereof. Other information can be displayed through the display matrix, such as a price estimate for one or each of the IP filings. The user's budgeted IP spending and/or the total estimated or actual IP spending for the IP portfolio, IP filings and/or the individual regions can also be displayed through the display matrix. Prior instructions and the status of those instructions may also be displayed.

The status may be readily indicated in a number of ways in the display matrix, such as using different colors, symbols, patterns, shading, borders and combinations thereof. Various other techniques such as sounds can be employed as the user interacts with the display matrix. The status information for each IP filing is also updated, desirably automatically, upon any change in the status of the IP filing. For example, an instruction to drop an issued IP filing or abandon a pending IP filing can be illustrated by a red dashed border around a corresponding cell within the display matrix, while the fill color of the cell continues to indicate the actual current state of the application. After the instruction is approved, the border changes to solid red. Finally after the instruction is carried out, the fill color of the cell changes to red to indicate the IP filing is dropped or abandoned.

In step 26, a request for an instruction for one or more of the IP filings is made to one or more interested parties. The instruction can involve various decisions that need to be made, and is often a filing instruction, such as relating to filing a particular application (e.g., an IP filing) for an IP asset, or a prosecution instruction, such as relating to a decision needed to be made in a filed application. In addition to a filing instruction and or a prosecution instruction, a request for a maintenance instruction may be made. The maintenance instruction maybe relating to a decision regarding paying on-going maintenance fees such as annuities or taxes. In one embodiment of this invention, the request can be made through a signal for the appropriate IP filing(s) displayed in the display matrix, such as a color change for the IP filing or a flashing indicator. Alternatively, the request can be communicated by the computer system by automatically sending an electronic communication, such as an e-mail or instant message, to the interested party. While the generation and sending of such an electronic request is optional, and may not be necessary where users can be counted on for systematically reviewing the display matrix, the electronic request is particularly useful in notifying and reminding interested parties that the instruction is needed.

In step 28, the instruction, e.g., the filing or prosecution instruction, is obtained for the IP filing through the display matrix. Desirably, the interested party giving the instruction electronically enters the instruction through a link in the display matrix. In one embodiment of this invention, by selecting the link, which is desirably identified with the corresponding IP filing that the instruction is related to, a new browser window opens to receive the instruction. The interested party selects or otherwise enters the instruction, e.g., file, abandon or pay a maintenance fee. The browser window optionally includes an area for typing a note including additional information desired for explaining or supporting the instruction.

In one embodiment of this invention, the obtained instruction is optionally automatically forwarded to another interested party in step 30. For example, the computer system can generate an e-mail message to the final decision maker or instruction follower, such as the IP attorney, or to all users associated with the IP portfolio, that the instruction has been made. The system could also allow users associated with other IP portfolios to receive messages on IP assets and/or IP filings that they may be interested in, such as to have the option to assume responsibility for IP filings dropped by the original controlling party. In other embodiments that use additional instructions and/or approval steps, the system can generate automatic messages when any or all of such steps are completed to keep the appropriate parties informed.

The method and system of this invention may optionally include one or more rating scales to improve the consistency of decision making across multiple IP portfolios, users, business groups, clients, etc. The rating for an IP asset and/or IP filing can be shown or otherwise indicated through the display matrix as an informational aid in determining and providing the instruction. In one embodiment of this invention, the method includes rating for one or more of the IP assets at least one of a business interest and a legal interest. The business interest, generally stated, is the relative importance of, or interest in, the IP asset to the business of the owner. An IP asset can be rated by one or more system users, business groups and/or other relevant party according to various and alternative factors known to IP asset owners to assess the business interest of the IP asset. Whether the IP asset is important and valuable, a key or base technology, or a slight or incremental improvement are examples of factors that that can influence or determine the business interest rating value. The legal interest, generally stated, is the legal assessment of an IP asset, such as is often made by an IP attorney or manager. Example factors that can influence or determine the legal interest rating include the breadth of patent claim scope, whether the initial filing was as a defensive publication, and/or the extent of the prosecution history including oppositions, appeals, and reexaminations. As will be appreciated by those skilled in the art following the teachings herein provided, there can be overlap in factors used to rate or determine the business and legal interests, as factors used for determining the legal interest can also be used in rating the business interest, and vice versa.

In another embodiment of this invention the business and legal interests are used to determine a filing assessment for one or more of the IP filings. The filing assessment can be used to suggest the extent of worldwide filing for a particular IP Asset. The filing assessment for an IP filing is determined as a function of the general filing interest in a particular region and the business interest and/or the legal interest for the IP Asset. The filing interest for the region can be determined in various ways, such as by considering a parameter such as, for example, a potential or actual market value of the region, a competition assessment of the region, a legal system assessment of the region, and combinations thereof. The relative costs to obtain and or maintain the IP filing may also be considered in determining the filing interest in a particular region. The filing assessment for the IP filing is desirably indicated through the display matrix to assist in making filing and/or prosecution decisions. All such rating scales of this invention can be continuous or incremental, and various weighting factors and/or algorithms can be used to calculate the priority or overall score. As is well known in the art, users can enter such data directly into various files such as spreadsheets, databases, text files, etc., or can be entered onto web pages, or forms that are linked to data storage files or systems.

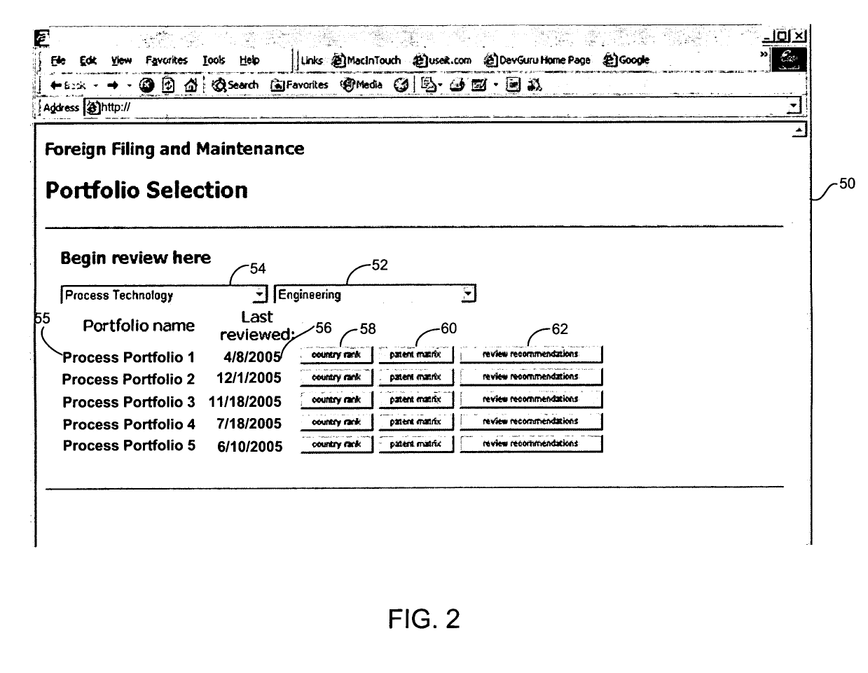

FIGS. 2-8 are screen displays showing a computer system implementing the method of one embodiment of this invention. FIG. 2 shows a portfolio selection display screen 50, which lists the IP portfolios 55 of the system user. In the particular embodiment shown, the five IP portfolios 55 are controlled by the engineering division, as indicated in the dropdown box 52 and are related to process technology, as indicated in the dropdown box 54. Using the optional dropdown boxes 52 and 54, the system user can easily jump to other portfolio selection screens for viewing listings of other IP portfolios of other technologies or industries, or controlled by other groups or divisions. As will be appreciated by those skilled in the art following the teachings herein provided, the number of IP portfolios and the organization of the IP portfolios can vary according to the needs of the system user.

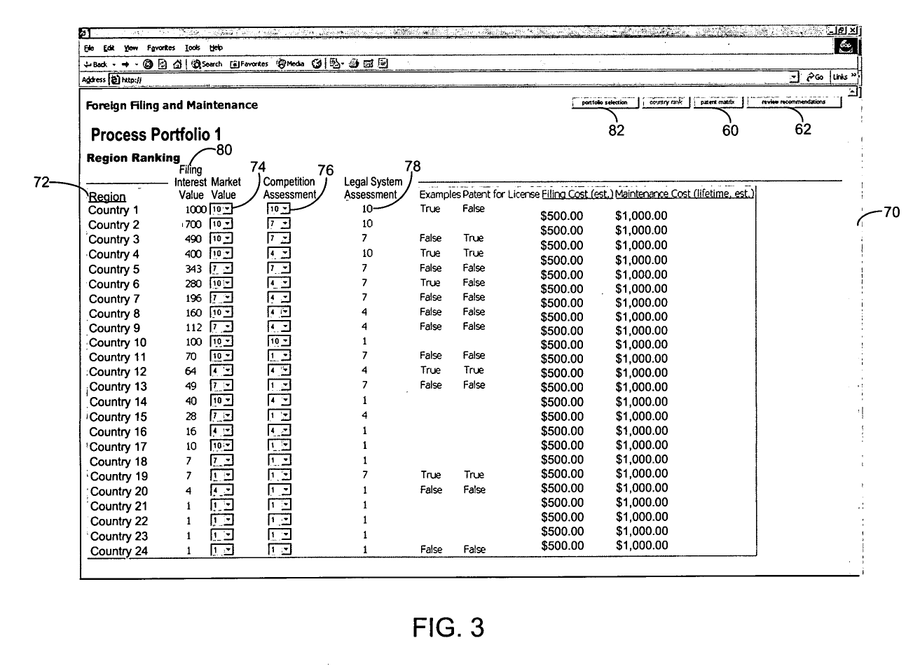

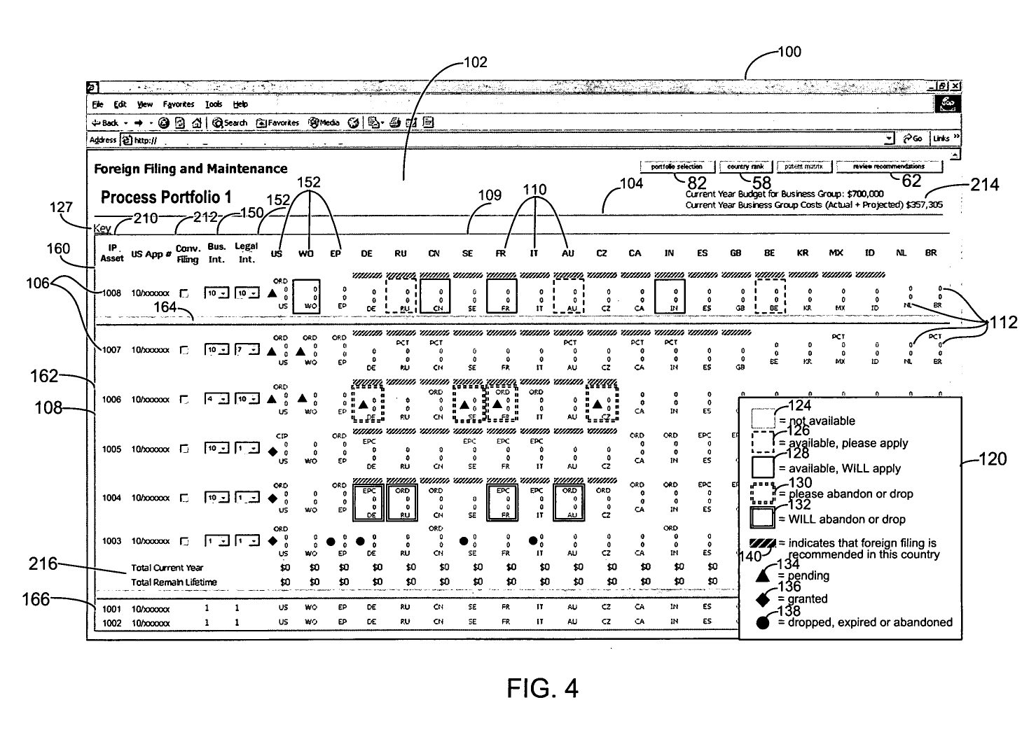

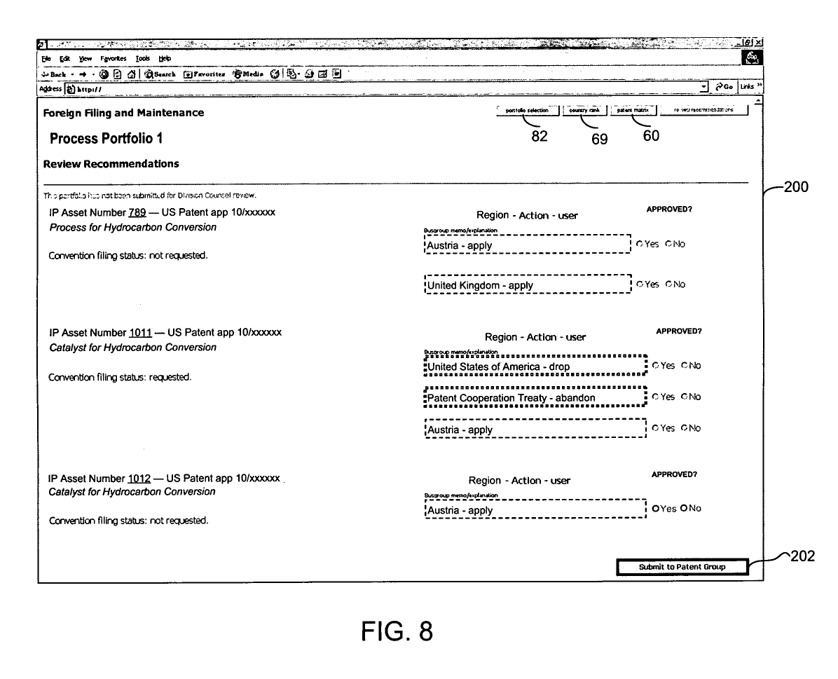

For each IP portfolio 55 the screen 50 displays the last date 56 the IP portfolios 55 were reviewed, which may be desirable to remind a user to open and review one of the IP portfolios 55 for upcoming decisions. The date 56 can optionally turn color, such as red, to indicate that a review has not occurred in a particular period of time, such as in more than five months. Also, for each of the IP portfolios 55, there is a plurality of navigation buttons for linking to further display screens of interest within the system. For each IP portfolio 55 there is a country rank button 58, a display matrix button 60 and a review recommendations button 62. The country rank button 58 links to a display screen represented by FIG. 3. The display matrix button 60 links to a display screen represented by FIG. 4. The review recommendations button 62 links to a display screen represented by FIG. 8.

The user clicks on or otherwise selects one of the country rank buttons 60 to open the corresponding display screen 70 in FIG. 3. Through the display screen 70, the system receives ranking information for a plurality of regions for which IP application filings are offered. The display screen 70 includes a listing 72 of a plurality of regions that are to be rated according to the business interest. The business interest for each region (Regions 1-24) is rated according to a market value and a competition assessment for that region. The market value can be entered on a numerical scale, for example, of one to ten using the dropdown box 74. Likewise the competition assessment can be is rated using the same scale through the dropdown box 76. Variations, such as a four-point numerical scale discussed further below, are available may be preferred to more accurately differentiate the rating values for the regions.

The remaining columns shown to the right of the competition assessment rating column are locked and not entered by the user through screen 70. This is an example of additional information that may be included in a database associated with the system and is region specific information that does not vary according to the nature of the IP Portfolio. Such information may include assessments, summarize legal issues, and other information useful for comparing the regions. For example, the legal system assessment 78 according to one embodiment of this invention is rated according to the region's legal system in general, such as the strength of the region's patent system and/or the region's court system for enforcing issued patents, and is independent of the particular I/P asset. The legal system assessment rating is desirably done by a legal professional, whereas the market value rating and competition assessment are desirably done by a manager or other member of the business group controlling the IP portfolio. In the particular embodiment shown in FIG. 3, the legal system assessment is made using a four-point scale, with “10” indicating a preferred filing region, “7” indicating an average filing region, “4” indicating a less preferred filing region, and “1” indicating no filing is recommended in that region. Each filing interest value in listing 80 is determined in the illustrated embodiment by multiplying the corresponding market value rating in box 74, the competition assessment rating in box 76, and the legal system assessment rating 78. The display screen 70 also includes a navigation button 82 for returning to the IP portfolio screen 50, and the matrix button 60 and the review recommendations button 62 discussed above.

The filing interest values 80 for the regions in the illustrated embodiment of this invention are performed collectively for each IP asset by rating the corresponding IP portfolio as a whole. As the IP assets in each IP portfolio are generally related, the filing interest values 80 can be applied to each IP asset to determine a filing assessment for the individual IP filings. In this manner, the user does not need to assess and enter the filing interest ratings per region individually for each IP asset, thereby saving the user time. In another embodiment of this invention, the filing interest for each region is entered for each IP asset separately.

Selecting or clicking the navigation button 60 in either screen 50 or 70 opens or directs the user to the display screen 100 of FIG. 4. FIG. 4 illustrates a display matrix 102 according to one embodiment of this invention.

The display matrix 102 includes a table 104 listing the IP assets 106 of the IP portfolio along a first axis 108, which is the vertical y-axis in table 104. The table 104 lists a plurality of regions 110 along a second axis 109, which is the horizontal x-axis in table 104. Each of the regions 110 is a country or other organized region for which a filing an application for patent, invention certificate, registration, etc. (i.e., an IP filing) is available. Regional offices such as the PCT, EPO, EA, OA, and AP can be treated the same as individual countries within the method and system of this invention. The table 104 includes a plurality of cells 112 aligned with, and disposed at the intersection of, an IP asset 106 of the first axis 108 and a region 110 of the second axis 109. Each cell 112 is or represents an IP filing for the correspondingly aligned IP asset 106 in the correspondingly aligned region 110. As will be appreciated, various and alternative configurations are available for the display matrix according to this invention, particularly depending on the needs of a particular client. For example, although the IP assets are shown as rows and the regions as columns in FIG. 4, these can of course be switched.

In one embodiment of this invention, the display matrix 102 simultaneously includes and displays all of the IP assets 106, and the IP filings for the IP assets, for or within the IP portfolio. As will be appreciated, a scroll feature may be necessary to view the simultaneously displayed IP assets and IP filings in the display matrix, such as due to screen size limitations, but a single display matrix desirably includes all of the IP assets and IP filings to facilitate review.

The display matrix 102 is generated using records of IP filings stored in a database and or other data storage portion of the system. The status of each IP filing is indicated or communicated through the corresponding cell 112, so that the information is available for providing informed instructions related to the IP filing. The status of each IP filing may be readily indicated in a number of ways, such as, for example, using different colors, symbols, patterns, shading, boarders, etc. and combinations thereof within the cell 112. Various other techniques, such as sounds, can be employed as the user interacts with the display matrix 102.

The display matrix includes a key 120 that can be displayed or opened in a new window by the user through a key link 122. The key 120 illustrates an exemplary system for indicating the status of each IP filing in the display matrix 102. In the exemplary embodiment of FIG. 4, a shading 124 of a cell 112 indicates that no filing is currently available for the IP filing, either because the appropriate filing time has not yet occurred or because it has passed. A dashed border 126 around a cell 112 indicates that a filing opportunity is available for the IP-asset 106 in the correspondingly aligned region 110, and that a user has provided an instruction to execute the filing. When the dashed border 126 becomes a solid border 128, a reviewing user, such as the responsible patent attorney, has accepted the instruction and will execute the filing in that region 110. Similarly, a double dashed border 130 indicates that a user has provided an instruction to abandon or drop a filed and pending or issued and enforceable IP filing. When the double dashed border 130 becomes a double solid border 132, a reviewing user, such as the responsible patent attorney, has accepted the instruction and will abandon or drop the IP filing in that region 110. A triangle 134 disposed in a cell 112 indicates an IP filing is pending, a diamond 136 indicates an IP filing is granted, and a circle 138 indicates an IP filing is dropped, expired or abandoned. As will be appreciated by those skilled in the art following the teachings herein provided, various and alternative indications are available for indicating or communicating the status of an IP filing in the cells of the display matrix, such as, for example, various color shadings, such as green for approved IP filings and red for dropped, expired or otherwise unavailable I/P filings.

The striped bar 140 indicates a filing assessment of a recommended IP filing when placed near the top of a cell 112. As discussed above, the filing assessment for each IP filing is desirably determined automatically by the system of this invention as a function of the filing interest of the region 110 and the business interest and/or the legal interest of the IP asset 106. The filing interest was determined by the system using values inputted through display screen 70 of FIG. 3. In the embodiment of the invention illustrated in FIGS. 2-8, the business interest is entered through corresponding drop down boxes in column 150 of the display matrix 102. The legal interest is likewise entered through corresponding drop down boxes in column 152 of the display matrix 102. In the embodiment shown in FIG. 4, the business interest and legal interest are also made using a four-point scale, with “10” indicating a preferred or highly valued IP asset, “7” indicating an above average value or interest, “4” indicating a below average value or interest, and “1” indicating little or no interest in the IP asset. Desirably, the business interest is determined by or with input from the controlling person or business group, and the legal interest is determined with by or with input from a legal department or IP professional, such as a corporate patent group or outside patent counsel.

The filing assessment for each of the IP filings can be determined by various and alternative algorithms known and available to those skilled in the art. In one embodiment of this invention, for each IP filing the filing interest value of that region is automatically combined mathematically, such as by addition or multiplication, with the business interest and legal interest values of the corresponding IP asset. The system compares the resulting combined value to a predetermined scale. When the combined value is above a particular threshold, the system determines the filing assessment for the IP filing to be “recommended” or otherwise possibly of interest, and so indicates and draws attention to that IP filing by placing the striped bar 140 in the cell 112 representing that IP filing.

The IP assets within the display matrix can be sorted in a variety of ways. In one embodiment, the IP assets are listed according to the date of their initial submission to the appropriate manager or legal department. In another embodiment they are listed according to the filing date of the first IP filing, such as the U.S. patent application filing date. In another embodiment, an algorithm is used to determine if any possible filing decisions remain for each IP asset. Those IP assets where filing decisions are still possible are listed in one part of the display matrix and the IP assets for which no more filing is possible are listed in another section of the display matrix. As shown in FIG. 4, the display matrix 102 has an upper first matrix portion 160 and a lower second matrix portion 162 separated by a divider 164. The first matrix portion 160 includes IP assets for which a filing opportunity is still available and the second matrix portion 162 includes IP assets for which no filing opportunity is still available. The system may automatically move an IP asset from the first matrix portion 160 to the second matrix portion 162 when no filing opportunity remains. It is preferred to display both matrix portions in one display matrix as shown in FIG. 4, but they can be displayed on separate linked screens if desired. The IP assets in each matrix portion can be further sorted according to any data desired. The sorting data may be different or the same in each matrix portion of the display matrix 102.

The regions may also be sorted in a variety of ways. The regions may be displayed in a fixed order or dynamically resorted by the system for example to display them in order of the current filing interest value. In another embodiment, some of the regions may be displayed in a fixed order while others are dynamically sorted. For example, regional offices and/or selected countries may be listed first followed by a dynamically sorted list of the remaining regions. In another embodiment a regional office may be followed by a listing of its members. Various sorting methods may be combined as desired. As for the IP assets, it is preferred all of the listed regions in one display matrix, but they can be displayed on separate screens if desired.

Additional portions or sections can also be shown in a display matrix according to this invention. For example, an IP asset may be associated (be displayed) in one IP portfolio, but it may also impact, or be of interest in, a different IP portfolio. In one embodiment, an IP asset may be associated with multiple IP portfolios. As shown in FIG. 4, a third matrix portion 166 displays IP assets of a different IP portfolio that have been identified by the user as relevant to this IP portfolio. Instructions made and the status of IP filings in the other IP portfolio are shown in matrix portion 166 as well, such as using the codes in key 120. Such a system would provide the maximum information for decision making purposes, and appreciates the likely interconnection of IP portfolios, particularly in large corporate settings. However, if the system also includes means for obtaining instructions, discussed further below, this arrangement leads to the possibility of receive different instructions at different times. In another embodiment of this invention, each IP filing is associated with a single IP portfolio and input can only be made by users with the proper security access to that IP portfolio. IP assets displayed in matrix section 166 may be displayed as read only values in one or more other IP portfolios that are interested in those IP assets. Thus, users viewing one IP portfolio can see what is happening to, or the recommended course of action for, IP assets that are of interest to them so they can take action if necessary.

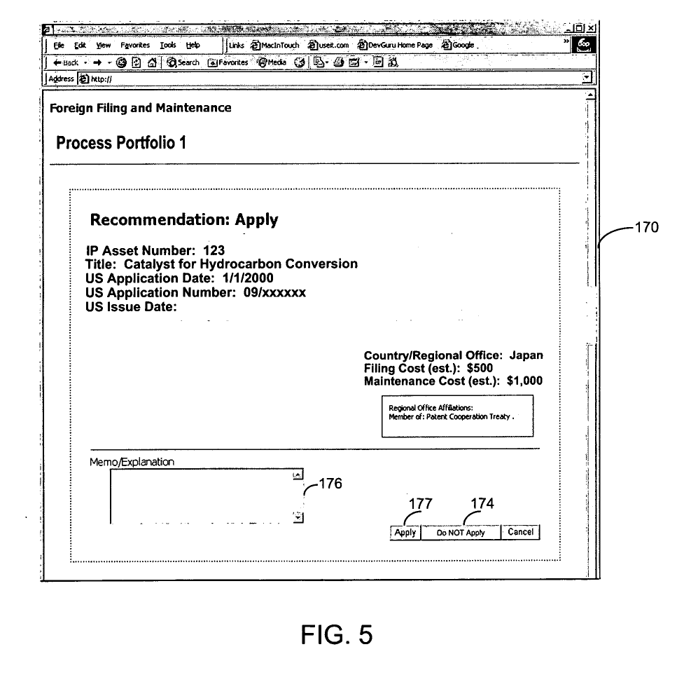

The system and display matrix of this invention implement the obtaining of an instruction for an IP filing according to the method of this invention. In one embodiment of this invention, the cells 112 in the display matrix 102 are active links that can be selected or activated by clicking with a mouse (or a mouse over event) to display a dialog box, selection list, or, as shown in FIGS. 5-7, a new window for entering an instruction. The user enters the instruction for the IP filing through, for example, the new window.

FIG. 5 is a new 170 window opened by clicking on a cell 112 for an IP filing for which a filing in the corresponding region 110 has not yet occurred. The window 170 indicates the instruction to be entered, namely to apply for a patent in the corresponding region (Japan in FIG. 5). The user has the option to provide instructions to apply by clicking button 172 or to not apply by clicking button 174. Information such as, for example, the estimated cost for the filing and/or the prosecution of the IP filing can be listed in window 170. An optional memo box 176 can be included for the user to provide an explanation for the instruction or provide other information that may be beneficial for others, such as a reviewer, who will look at the instruction at a later time.

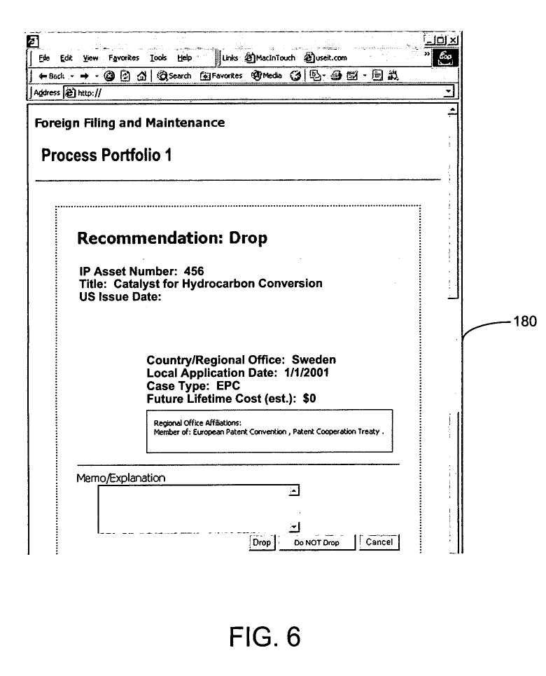

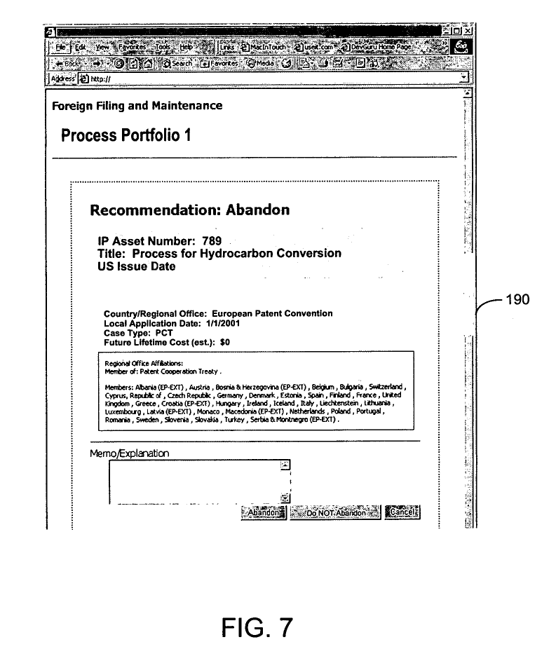

FIG. 6 is another new window 180 that appears when a cell 112 for an issued IP filing is selected from the display matrix 102. The window 180 provides the user with the ability to enter the instruction to drop the issued IP filing, such as by not paying an upcoming maintenance fee. FIG. 7 is yet another new window 190, which appears when a cell 112 for an approved or pending IP filing is selected. The window 190 is analogous to the window 180 and allows the user to enter an instruction to abandon the approved or pending application of the IP filing. As will be appreciated by those skilled in the art following the teachings herein provided, various and alternative means and configurations of windows are available for obtaining an instruction through the display matrix according to this invention.

In one embodiment of this invention, the system communicates to the system user, desirably the interested party who will provide the needed instruction, that an instruction is needed for one or more IP filings. The communication comes at one or more predetermined times before the instruction is needed, such as, for example, at six months before a filing deadline. In one embodiment, the communications can be through the display matrix 102, such as a color coded or flashing cell 112 for the particular IP filing needing the instruction. In another, preferred embodiment, the system automatically sends an electronic communication, such as an e-mail or instant message, to the one or more interested parties. Upon receiving the electronic communication, the interested party opens the display matrix, such as through a link in the e-mail, and selects the cell 112 for the IP filing needing the instruction.

Users may enter instructions in a variety of ways as described above which are immediately effective in the system. In other embodiments, these instructions may be recorded but are not made effective until the user submits them. Such an embodiment provides for a chance to ensure the proper instruction is being sent. For example, FIG. 8 is an optional window 200 that can be opened by clicking the review recommendation button 62. The window 200 lists and summarizes the current instructions that are pending for review. The window 200 allows the user to review each of the instructions made through the display matrix 102 before final submission to the reviewing party, such as the responsible patent attorney. When the user has reviewed the instructions, the user selects the button 202 to submit the instructions to the responsible person(s) for review or completion. In one embodiment of this invention, upon selecting button 202, the system automatically generates and sends an electronic message to the responsible person(s) to notify the person(s) that an instruction is awaiting action. In one embodiment the instruction is sent to the responsibility person such as the agent, attorney, or docket clerk to complete the instruction. In other embodiments, the instruction may be sent to be approved before action is taken. In complex organizations there may be a number of instruction submission and/or approval steps. For example, the list in FIG. 8 may include an approval section, and the display matrix 102 is desirably updated to indicate the decisions. In some embodiments, the system or portions of it such as the instructions listed in FIG. 8, or the IP assets or portfolios involved are desirably locked upon submission to the responsible person(s), thereby avoiding any confusion and errors due to possible multiple instruction submissions. The system or relevant portions of it may be unlocked when appropriate such as after the instruction is approved, acknowledge, or acted upon.

Desirably, after each instruction or other change in status of an IP filing the display matrix 102 is updated to reflect the instruction or other change in status. By updating the IP filing status indicated in the cells 112 of the display matrix 102, the method and system of this invention provide an efficient and thorough summary of information needed to manage an IP portfolio and make filing and prosecution decision for individual IP filings. The method and system of this invention find utility with as few as two IP assets or filings, but are particularly useful in assisting business groups and patent groups of larger companies to manage the company's more extensive intellectual property.

As shown FIG. 4, the display matrix 102 can include other optional features to further enhance the decision making process. For example, the display matrix can be displayed on a web browser and contain links that provide more details. For example, by clicking on the IP asset name or number in column 210, a new web page opens which provides additional details stored in a database concerning the original disclosure of the IP asset, or it can open the original disclosure or an image of it. Another link, such as clicking the U.S. patent application serial number in column 212, can be used to access the granted patents and/or publications directly from the U.S. Patent and Trademark Office web site. Other links for the equivalent web sites from other countries' patent offices can also be included. The system may include links to prosecution history files. The system can include and/or be linked to estimated and/or actual cost data for the IP portfolio, such as cost summary 214, and/or the individual region, such as cost summary 216, and or cost summary data for each IP asset, not shown.

Thus this invention provides a method and system for managing intellectual property. This invention provides an intellectual property manager with sufficient and updated information to be able to provide informed and efficient instructions to a final decision maker, or an agent who acts out the instruction. The method and system can be paired with, or incorporated into, current docketing systems to provide intellectual property owners and managers with a robust system that allows for efficient, timely and informed decision making.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A method of managing intellectual property (IP), the method comprising:
displaying an IP filing for an IP asset in a display matrix on a computer screen;
indicating a status for the IP filing through the display matrix; and
obtaining an instruction selected from the group consisting of a filing instruction and a prosecution instruction, for the IP filing through the display matrix.

2. The method of claim 1, wherein the status is selected from the group consisting of an availability status, a filing status, a pendency status, an issuance status, an enforceability status, and combinations thereof.

3. The method of claim 1, additionally comprising indicating a price estimate for the IP filing through the display matrix.

4. The method of claim 1, additionally comprising automatically updating the status for the IP filing to indicate the instruction.

5. The method of claim 1, additionally comprising:
rating for the IP asset at least one of a business interest and a legal interest; and
indicating the rating for the IP asset through the display matrix.

6. The method of claim 1, additionally comprising grouping a plurality of IP assets in an IP portfolio, wherein the display matrix simultaneously displays all of the IP assets for the IP portfolio.

7. The method of claim 6, wherein the display matrix comprises a first matrix portion and a second matrix portion, wherein the first matrix portion includes IP assets for which a filing opportunity is available and the second matrix portion includes IP assets for which no filing opportunity is available.

8. The method of claim 1, additionally comprising communicating a request for the instruction by automatically sending an electronic communication to an interested party.

9. The method of claim 8, wherein obtaining the instruction comprises the interested party entering the instruction electronically by selecting a link through the display matrix.

10. The method of claim 1, wherein the instruction is electronically forwarded to another interested party.

11. The method of claim 1, wherein the display matrix comprises a table listing the IP asset along a first axis, listing a region along a second axis, and a cell correspondingly aligned with the IP asset along the first axis and the region along the second axis, the cell indicating the IP filing for the IP asset in the correspondingly aligned region.

12. The method of claim 11, wherein obtaining the instruction comprises an interested party selecting the cell through the display matrix and entering the instruction.

13. The method of claim 11, additionally comprising:
determining for the I/P asset at least one of a business interest and a legal interest;
determining a filing interest for the region;
automatically determining a filing assessment for the IP filing in the region as a function of the filing interest and the at least one of the business interest and the legal interest; and
indicating the filing assessment for the IP filing through the display matrix.

14. The method of claim 13, wherein determining the filing interest comprises considering a parameter selected from a group consisting of a market value, a competition assessment, a legal system assessment, and combinations thereof.

15. The method of claim 1 further comprising obtaining a maintenance instruction for the IP filing through the display matrix.

16. A method of managing intellectual property (IP), the method comprising:
viewing IP filings for an IP asset in a display matrix on a computer screen; and
providing an instruction selected from the group consisting of a filing instruction and a prosecution instruction, for one of the IP filings through the display matrix.

17. The method of claim 16, wherein the display matrix indicates a status for the IP filings, the status selected from the group consisting of an availability status, a filing status, a pendency status, an issuance status, an enforceability status, and combinations thereof.

18. The method of claim 16, additionally comprising rating for the IP asset at least one of a business interest and a legal interest.

19. The method of claim 16, additionally comprising viewing IP filings for a plurality of IP assets, wherein the display matrix simultaneously displays all of the IP filings.

20. The method of claim 16, additionally comprising receiving an automated electronic communication requesting the instruction.

21. The method of claim 16, wherein providing the instruction comprises entering the instruction electronically by selecting a link for the IP filing through the display matrix.

22. A method of managing intellectual property (IP), the method comprising:
displaying IP assets of an IP portfolio in a display matrix on a computer screen;
displaying an IP filing in a region for one of the IP assets;
determining a filing assessment for the IP filing;
indicating the filing assessment through the display matrix; and
obtaining an instruction for the IP filing.

23. The method of claim 22, additionally comprising determining the filing assessment as a function of at least one of a business interest of the one of the IP assets, a legal interest of the one of the IP assets, and a filing interest in the region.

24. The method of claim 23, wherein the filing interest is determined from a parameter selected from the group consisting of a market value, a competition assessment, a legal system assessment, and combinations thereof.

25. The method of claim 22, additionally comprising displaying a plurality of IP filings for each of the IP assets, each of the plurality of IP filings corresponding to one of a plurality of regions.

26. A system for managing intellectual property (IP), the system comprising:
a network including more than one user interface;
a database for storing information about an IP asset; and
software including code for creating a display matrix within a browser for viewing on the more than one user interface, the display matrix including a table listing the IP asset along a first axis and listing a region along a second axis, the table including a cell correspondingly aligned with the IP asset along the first axis and the region along the second axis, the cell representing an IP filing for the IP asset in the correspondingly aligned region.

27. The system of claim 26, wherein the cell displays a status for the IP filing.

28. The system of claim 26, wherein the cell comprises a link for entering an instruction.

29. The system of claim 26, wherein the software comprises code for automatically generating an electronic communication to an interested party requesting an instruction at a predetermined time before a due date for the IP filing.

30. The system of claim 26, wherein the display matrix comprises a table listing a plurality of IP assets along the first axis.

31. The system of claim 30, wherein the display matrix comprises a cell for each of the plurality of IP assets, the cell representing the IP filing in the correspondingly aligned region.
